(19) United States
(12) Patent Application Publication
(10) Pub. No.: US 2010/0143836 A1
(43) Pub. Date: Jun. 10, 2010

(54) ELECTROPHOTOGRAPHIC TONER

(75) Inventors: Atsuo Miyamoto, Shizuoka-shi (JP); Shinji Yoshizaki, Shizuoka-shi (JP); Toshiyuki Shirai, Shizuoka-shi (JP)

Correspondence Address: WOOD, HERRON & EVANS, LLP, 2700 CAREW TOWER, 441 VINE STREET, CINCINNATI, OH, 45202, US

(73) Assignee: TOMOEGAWA CO., LTD., Tokyo (JP)

(21) Appl. No.: 12/294,730

(22) PCT Filed: Mar. 28, 2007
(86) PCT No.: PCT/JP2007/056647

§ 371 Date: Sep. 26, 2008

(30) Foreign Application Priority Data
Mar. 28, 2006 (JP) 2006-087219

(51) Int. Cl. G03G 9/08; G03G 9/083

(52) U.S. Cl. 430/111.4

(57) ABSTRACT

This invention provides a toner for a method for image formation by electrophotography, particularly a toner that, in a one-component development method, has stable fluidity and electrostatic properties for a long period of time, is free from image defects, and is also excellent in transferability and transfer efficiency. The toner for electrophotography comprises matrix toner particles and at least titanium oxide fine particles and fluidizer fine particles deposited on the surface of matrix toner particles. The titanium oxide fine particles are spherical and have an average primary particle diameter of 200 to 400 nm. The fluidizer fine particles have a specific surface area of 60 to 250 m²/g.

### TECHNICAL FIELD

The present invention relates to an electrophotographic toner which is used in an electrophotographic image forming method.

Priority is claimed on Japanese Patent Application No. 2006-087219, filed on Mar. 28, 2006, the contents of which are incorporated herein by reference in their entirety.

### BACKGROUND ART

In general, an image forming device, such as an electrophotographic copier and printer, has a basic principle in which latent images are formed on a photoconductor having photoconductive properties, carriers or insulating toner, which are frictionally charged by friction with a charging member constituting a developing device, are attached on the latent images, the formed toner images are transferred to a transfer medium, such as plain paper, and a film, and the transferred toner images are fixed by heating, pressurizing, or evaporating a solvent contained in the toner, and thereby copied images or printed images are formed.

The developer used in the electrophotographic method is classified into a two-component developer comprising a toner component and a carrier component, and a one-component developer comprising only a toner component. The one-component developer is further classified into a magnetic one-component developer comprising a magnetic toner and a non-magnetic one-component developer comprising a non-magnetic toner.

In all developers, in order to obtain excellent printed images which exert stable properties for a long time, it is important that the main toner has excellent fluidity and frictional charging properties for a long time, in addition to the initial properties.

In order to improve frictional charging properties of the toner, that is, fluidity of the developer, inorganic or organic fine particles as a fluidizer have been added and attached on the main toner particles. Examples of the fine particles include silica fine particles, titanium oxide fine particles, and alumina fine particles.

The toner is subjected to various stresses in the developing process. Specifically, the stresses are outlined below.
(1) In the two-component developer, stress caused by agitation and mixing with carriers, and the like.
(2) In a contact type one-component developer, stress caused by agitation blades in the developing device, stress caused by friction with a charged blade, and stress caused by contacting a developing sleeve with a photoconductor, and the like
(3) In a non-contact type one-component developer, stress caused by agitation blades in the developing device, and stress caused by friction with a charged blade, and the like

When the fluidizer has stability to these stresses, the toner comprising the fluidizer can exert a stable quality for a long time.

However, when the toner is subjected to the stress, the fluidizer is removed from the surface of the main toner particles, or embedded into the main toner particles. Thereby, the fluidizer gradually decreases the ability of applying fluidity.

In the contact-type one-component developing method, since the photoconductor contacts the toner on a non-magnetic sleeve, the developing properties are excellent. However, the toner is subjected to not only friction caused by agitation in the developing device, but also friction caused by contacting with the photoconductor. Therefore, a mechanical load to the toner is increased. As a result, problems, in that long life properties are degraded (the duration life of the developer is short), are caused. In addition, in particular, when the photoconductor is an organic photoconductor (OPC), the OPC is easily scratched

In the non-contact type one-component method, since the toner contacts only the charged blade in developing members, the mechanical load to the toner is relatively small.

However, there is an interval between the toner and the developing members in the non-magnetic contact method. Therefore, the toner is not readily transferred to the latent images compared to the contact type method. As a result, it is difficult to obtain sufficient image density. In addition, transferring of the toner to the latent images on the photoconductor depends largely on the charging conditions of the toner. Therefore, it is important to maintain stably the fluidity and charging properties of the toner.

As a method which solves the problems, a method in which an amount of the toner passing through the interval between the non-magnetic sleeve and the charged blade is increased by widening the interval has been examined. However, when the amount of the toner passing through the interval is increased, charging to the toner by the blade is insufficient. The friction charging amount of the toner is insufficient. As a result, a thin layer comprising the toner on the surface of the developing sleeve is uneven. When the thin layer comprising the toner is uneven, and an all blacked or half tone document is developed, problems such as the images are thin or insufficient, and the image density is insufficient are caused.

Moreover, in a case of the magnetic toner, since a magnetic roller transfers the toner, the magnetic toner is subjected to less stress compared to the non-magnetic toner. Therefore, the magnetic toner easily obtains long-life properties.

When the thin layer comprising the toner on the surface of the developing sleeve is uneven, of course, these problems are caused in the contact type method.

In summary, it is important that the thickness of the thin layer comprising the toner be improper and uniform, the image density be high, and that it has long life properties (high image density is maintained after plural continuous printing) in the one-component developing method. In addition, when considering that an image is required to have high quality in recent years, it is important to maintain not only the image density for a long time, but also that image defects are not caused in continuous printing.

Examples of the image defects include the following.

(1) Insufficient or thinning of the image (This phenomenon is caused when fluidity or friction charging properties of the toner are inferior, a sufficient amount of the toner is not supplied to the developing roller or the photoconductor. In particular, this phenomenon is easily generated in printing a document in all black, which needs a large amount of the toner.)

(2) Background fogging

(3) Black spot (This is also called “BS”. This phenomenon is caused in the images by generation of filming on the surface of the photoconductor, or damage of the photoconductor due to scratches.)

(4) Lines (This phenomenon is caused in the images by melting and attaching the toner on the surface of the charged blade or the developing roller.)

(5) Ghost (In the present invention, “ghost” means the phenomenon in which after the transferring process, the toner remaining on the surface of the photoconductor is transferred again. In particular, this phenomenon is caused when the photoconductor does not comprise a cleaning device.)

(6) Poor fine line repeatability (In an image with high quality, repetition of fine lines is required. This is the phenomenon in which when transferring properties and fluidity of the toner are inferior, fine lines are thinned.)

Due to simplification of clerical work, long life properties are increasingly desired. In addition, when high quality of the images, and decrease of print cost are concerned, good transfer properties, and good transfer efficiency (the amount of the toner remaining on the surface of the photoconductor after transferring is less) are also gradually emphasized.

In order to satisfy these demands, the toner is desired to have excellent fluidity, and maintain well-balanced improper charged conditions for a long time. However, it is not easy to select the most suitable kind and amount of fine particles as an additive which control the properties. Therefore, the request for long life properties in recent years has not been satisfied.

For example, Japanese Unexamined Patent Application, First Publication No. H05-346681 (Patent Document No. 1) discloses a toner which comprises spherical titanium oxide which is subjected to hydrophobic treatment and silica as an additive, has high fluidity, and is easily frictionally charged. In addition, Japanese Unexamined Patent Application, First Publication No. H06-11887 (Patent Document No. 2) discloses a toner which comprises titanium oxide of which the surface is subjected to a hydrophobic treatment with silica as an additive. However, these toners do not have the long-life properties that were expected.

Patent Document No. 1: Japanese Unexamined Patent Application, First Publication No. H05-346681

Patent Document No, 2: Japanese Unexamined Patent Application, First Publication No. H06-11887

### DISCLOSURE OF THE INVENTION

### Problems to be Solved by the Invention

An object of the present invention is to provide an electrophotographic toner used in electrophotographic image forming methods, in particular, the one-component developing method, which has stable fluidity and charging properties for a long time, excellent transfer facility, can form a uniform toner layer on the developing roller, and does not cause image defects. In addition, another object of the present invention is to provide a toner which has excellent transfer properties, and transfer efficiency.

### Means for Solving the Problem

In order to achieve the object, the present invention provides an electrophotographic toner (abbreviated as “a toner” below) comprising main toner particles and at least titanium oxide fine particles and fluidizer fine particles which are attached on the surface of the main toner particles, wherein the titanium oxide fine particles are spherical and have an average primary diameter in a range from 200 to 400 nm, and the fluidizer fine particles have a specific surface area in a range from 60 to 250 m²/g.

It is preferable that a circularity coefficient of the titanium oxide fine particles be 0.55 or greater.

It is preferable that a surface of the titanium oxide fine particles be treated with silicone oil.

In addition, it is also preferable that the titanium oxide fine particles are produced by a sulfuric acid method.

### Effects of the Present Invention

The toner of the present invention is used in electrophotographic image forming methods, in particular, the one-component developing method, and has stable fluidity and charging properties for a long time, excellent transfer facility, can form a uniform toner layer on the developing roller, and does not cause image defects. In addition, the toner of the present invention has excellent transfer properties and transfer efficiency.

### BRIEF DESCRIPTION OF THE DRAWINGS

FIG. 1 is an electron micrograph of the titanium oxide fine particles B used in Examples 1, 4, and 7.

FIG. 2 is an electron microgram of the titanium oxide fine particles D used in Comparative Examples 1, 7, and 13.

FIG. 3 is an electron microgram of the titanium oxide fine particles G used in Examples 4, 10, and 16.

FIG. 4 shows a pattern used in evaluation of the ghost.

### BEST MODE FOR CARRYING OUT THE INVENTION

As a result of conducting diligent research that focused on an additive which exerts fluidity and frictional charging properties for a long time, the inventor of the present invention achieved the present invention.

The toner of the present invention comprises main toner particles, and at least a first additive which is titanium oxide fine particles and a second additive which is fluidizer fine particles. The first and second additives are attached to the surface of the main toner particles. The titanium oxide fine particles are spherical and have an average primary diameter in a range from 200 to 400 nm. The fluidizer fine particles have a specific surface area in a range from 60 to 250 m²/g.

In other words, as a result of conducting diligent research that focused on the combination between spacer fine particles as the first additive and the fluidizer fine particles as the second additives, the inventors of the present invention found that the problems are solved by adding the first additive which is titanium oxide fine particles having an average primary diameter in a range from 200 to 400 run and the second additive which is fluidizer fine particles having a specific surface area in a range from 60 to 250 m²/g to the main toner particles.

The amount of the titanium oxide fine particles added to 100 parts by weight of the main toner particles is preferably in a range from 0.1 to 3.0 parts by weight, more preferably in a range from 0.3 to 2.5 parts by weight, and most preferably in a range from 0.5 to 2.0 parts by weight. In particluar, 0.8 to 1.5 parts by weight is preferable. When the amount of the titanium oxide fine particles is 0.5 parts by weight or more, sufficient spacer effects can be obtained, and long life properties are further improved. When it is 3.0 parts by weight or less, the function of the fluidizer is not blocked, reproducibility of printing in all black is not affected, background fogging is not caused, and the transfer efficiency is not decreased. Therefore, problems of the transfer efficiency, ghost, and fine line repeatability are not caused.

The titanium oxide fine particles used in the present invention may be any one of anatase, rutile, or a mixture of anatase and rutile.

The titanium oxide fine particles are preferably produced by a sulfuric acid method. The steps of the sulfuric acid method are below.
1. Dissolving step: Dried and crushed ilmenite ore is dissolved in sulfuric acid, and a solution containing mainly titanium oxysulfate (TiOSO₄) and iron sulfate (Fe SO₄) is obtained.
2. Cooling and separation step: A concentrated solution is obtained by separating ferrous sulfate (FeSO₄.7H₂O), which is crystallized by cooling the solution, with a centrifugal device.
3. Hydrolysis step: The concentrated solution from which ferrous sulfate is removed is heated to separate titanium oxyhydroxide (TiO(OH)₂) and sulfuric acid. In order to shape the titanium oxide fine particles spheric, this step is preferably conducted under pressurized conditions,
4. Burning step: A white precipitate of titanium hydroxide obtained by hydrolysis is fully washed with water and filtrate, and then burned to obtain titanium oxide (TiO₂).
5. Finishing step: The burned titanium oxide is subjected to a surface treatment, filtrated, dried, and then crushed to obtain a final product.

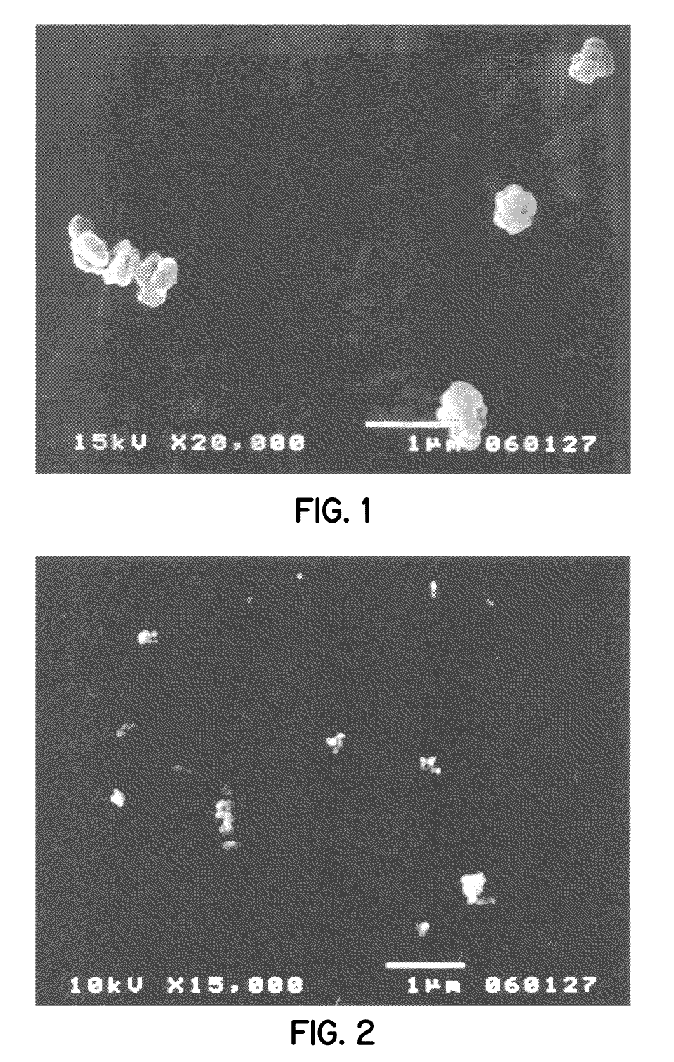

As shown in FIG. 1, the titanium oxide fine particles have a uniform primary particle diameter, and contain almost no ultra fine particles or large particles. In addition, the average primary particle diameter is in a range from 200 to 400 nm, and preferably in a range from 250 to 370 nm.

When the average primary particle diameter of the titanium oxide fine particles is 200 nm or greater, they function sufficiently as spacers. As a result, the fluidizer fine particles are not readily embbedded, and long life properties are easily obtained.

In contrast, when it is 400 nm or less, fluidity is not degraded.

The measurement method for the average primary particle diameter of the titanium oxide fine particles is described below.

Electron micrograms of the titanium oxide fine particles are taken by a scanning electron micrograph (marketed by JEOL Ltd.; trade name: JSM-5300). 100 titanium oxide fine particles are randomly selected in the electron microgram. Then, the long diameter D and the short diameter d of each titanium oxide fine particle are measured. Then, the value of (D+d)/2 is calculated. The average value of 100 titanium oxide fine particles is defined as the average primary particle diameter.

It is necessary that the titanium oxide fine particles be spherical. “Spherical” in the present invention means not only a perfect spherical, but also an almost perfect spherical, for example, an oval. When the titanium oxide fine particles are not spherical they have corners, thereby, it is impossible to obtain long life properties. In addition, problems such as scratching of the photoconductor are caused.

Specifically, the circularity coefficient of the titanium oxide fine particles is preferably 0.55 or greater, and more preferably 0.60 or greater.

“Circularity coefficient” used in the present invention is a value obtained below.

Electron micrograms of the titanium oxide fine particles are taken by a scanning electron micrograph (marketed by JEOL Ltd.; trade name: JSM-5300). 50 titanium oxide fine particles are randomly selected in the electron microgram. The circularity coefficient is analyzed and an average value automatically calculated using a particle size distribution analysis software of an image analysis type, Mac-View (Operation manual ver. 3 published on Mar. 18, 2005) marketed by MOUNTECH Co., Ltd.

The titanium oxide fine particles used in the present invention are preferably subjected to a surface treatment with silicone oil. When the surface of the titanium oxide fine particles is treated with silicone oil, hydrophobicity is applied, and charging properties are improved. In addition, since surface tension of the toner on the photoconductor is decreased, transferring properties of the toner are remarkably improved. Thereby, reproducibility of printing in all black, fine line repeatability and transfer efficiency are also improved.

The silicone oil used in the surface treatment for the titanium oxide fine particles preferably has a viscosity at 25° C. in a range from 10 to 1,000 centistroke, more preferably in a range from 20 to 300 centistroke, and most preferably in a range from 35 to 200 centistroke.

When the viscosity at 25° C. is 1,000 centistroke or less, the titanium oxide fine particles are easily attached on the surface of the main toner particles. However, when the titanium oxide fine particles are attached by applying in solution or emulsion conditions, and then drying, the viscosity is not in the range. In this case, the viscosity of the titanium oxide fine particles may be 1,000 centistroke or greater, like varnish.

The silicone oil contains preferably a volatile component of 1.5% by weight or less, and more preferably 0.7% by weight or less. The volatile component is a volatile component which is obtained by heating the silicone oil at 150° C. for 24 hours.

Examples of the silicone oil include dimethyl polysiloxane (dimethyl silicone oil), polysiloxane having a phenyl group, and alkyl-modified silicone oil. In addition, modified silicone oil, such as a-methylstyrene-modified silicone oil, chlorophenyl silicone oil, olefin-modified silicone oil, alcohol-modified silicone oil, fluorine-modified silicone oil, amino-modified silicone oil, mercapto-modified silicone oil, epoxy-modified silicone oil, carboxyl-modified silicone oil, high fatty acid-modified silicone oil, and amide-modified silicone oil, may be added depending on the charging properties of the toner.

The amount of the silicone oil added to 100 parts by weight of the titanium oxide fine particles is preferably in a range from 0.1 to 20 parts by weight, more preferably in a range from 0.2 to 10 parts by weight, and most preferably in a range from 0.5 to 5 parts by weight. In particular, a range from 0.7 to 3 parts by weight is preferable. When the amount of the silicone oil added is 0.1 parts by weight or greater, the silicone oil works effectively. When it is 20 parts by weight or less, the silicone oil is easily held by the titanium oxide fine particles. As a result, the fluidity of the developer is not decreased, the image density and uniformity of the image density are also not decreased, and various problems, such as background fogging, are not caused.

Examples of a method for treating the titanium oxide fine particles with the silicone oil include a method in which the titanium oxide fine particles are treated with an aqueous emulsion of silicone oil, a method in which they are treated with an organic solvent solution of silicone oil, a method in which the silicone oil is mixed with them by agitation, and a method in which the silicone oil is sprayed on them.

The titanium oxide fine particles used in the present invention may be subjected to a hydrophobic treatment with a silane coupling agent together with the silicone oil. Examples of the silane coupling agent include methyl trichlorosilane, dimethyl dichlorosilane, trimethyl chlorosilane, phenyl trichlorosilane, diphenyl dichlorosilane, tetramethoxysilane, methyl trimethoxysilane, dimethyl dimethoxysilane, phenyl trimethoxysilane, diphenyl dimethoxysilane, tetraethoxysilane, methyl triethoxysilane, dimethyl diethoxysilane, phenyl triethoxysilane, diphenyl diethoxysilane, isobutyl trimethoxysilane, decyl trimethoxysilane, hexamethyldisilazane, vinyl trichlorosilane, vinyl trimethoxysilane, vinyl triethoxysilane, γ-methacryloxy propyl tximethoxysialne, β-(3,4-epoxycyclohexyl)ethyl trimethoxysilane, γ-glycidoxypropyl trimethoxysilane, γ-glycidoxypropyl methyl diethoxysilane, γ-mercaptopropyl trimethoxysilane, γ-chloropropyl trimethoxysilane, γ-aminopropyl triethoxysilane, N-(β-aminoethyl)-γ-aminopropyl trimethoxysilane, γ-(2-aminoethyl)-γ-aminopropyl methyldimethoxysilane, and γ-anilinopropyl trimethoxysilane. They can be used alone or in combination.

A surface treatment method using the silane coupling agent comprises a dry method and a wet method. Specifically, a method, in which after spherical titanium oxide fine particles are dispersed in a silane coupling solution, the solvent contained in the solution is removed by filtering or spray-drying, and then they are dried by heating, can be used. In addition, a method, in which the silane coupling agent is sprayed to cover the spherical titanium oxide fine particles using a fluidized bed device, then they are heated and dried to remove the solvent contained, and thereby a coating film is formed, can also be used. Furthermore, a method, in which the spherical titanium oxide fine particles are put into a container which is filled with the silane coupling agent atmosphere, and they are mixed to form a coating film, can also be used.

The content of the titanium oxide in the titanium oxide fine particles which are attached on the main toner particles is preferably 90% or greater, and more preferably 94% or greater.

Conductive titanium oxide fine particles in which a conductive layer comprising tin oxide semiconductor is formed on the surface of the titanium oxide fine particles can also be used as long as the content of components other than titanium oxide is less than 10%, because the agglomerating properties thereof are not strong. Therefore, even if such conductive titanium oxide fine particles are used, there is no possibility that the fluidity of the toner degrades. In addition, since the conductive titanium oxide fine particles do not have sufficient conductivity, a sufficient frictional charging amount can be obtained.

Moreover, titanium oxide fine particles containing 10% or greater of components other than titanium oxide can be used together with the titanium oxide fine particles if necessary.

In the present invention, it is necessary to attach the fluidizer fine particles as “the second additive” on the main toner particles to apply fluidity, frictional charging properties, and stability to the toner. Examples of the fluidizer fine particles include inorganic fine particles and organic fine particles. Examples of the inorganic fine particles include silica fine particles, titanium oxide fine particles, alumina fine particles, zinc oxide fine particles, ceria fine particles, germania fine particles, and zirconia fine particles. They are used alone or in combination. In addition, fine particles containing these metal components can also be used. Among these, silica is preferable, and hydrophobic silica is more preferable. Silica is remarkably superior as a material which can apply fluidity and frictional charging properties to the toner.

The fluidizer fine particles are preferably subjected to a hydrophobic treatment. The kind and amount of a hydrophobic treatment agent may be selected depending on hydrophobicity, and other desired properties. Examples of the hydrophobic treatment agent include organopolysiloxane, organosiloxane, organosilazane, organosilane, halogeno organopolysiloxane, halogeno organosiloxane, halogen organosilazane, and halogeno organosilane. Among these, dimethyl dichlorosilane, trimethoxyoctylsilane, hexamethyl disilazane, polydimethyl siloxane, and circular silazane are preferable.

For example, when the toner has negative polarity, fluidizer fine particles which are treated with a coupling agent such as hexamethyl disilazane, dichlorodimethyl silane, polydimethylsiloxane are used. When the toner has positive polarity, fluidizer fine particles which are treated with an amino silane coupling agent can be used.

The specific surface area of the fluidizer fine particles is in a range from 60 to 250 m²/g, preferably in a range from 80 to 180 m²/g, and more preferably in a range form 115 to 150 m²/g. When the specific surface area is 60 m²/g or greater, fluidity is further improved. In contrast, when it is 250 m²/g or less, filming on the surface of the photoconductor is more reliably prevented.

The measuring method for the specific surface area is the BET method, and this is as shown below.

The specific surface area is measured using a high accuracy automatic vapor adsorption measurement (marketed by BEL Japan, Inc.; trade name: BELOSORP 28). As an inactive gas, N₂ gas is used as an adsorption gas. Specifically, an adsorption volume Vm (cc/g) of the adsorption gas which is necessary to form a monomolecular layer on the surface of the sample is measured, and then BET specific surface area S (m²/g) is calculated by the following formula.

S=4.35×Vm(m²/g)

The amount of the fluidizer fine particles added to 100 parts by weight of the main toner particles is preferably in a range from 0.1 to 3.0 parts by weight, more preferably in a range from 0.3 to 2.5 parts by weight, and most preferably in a range from 0.5 to 2.0 parts by weight. In particular, 0.7 to 1.3 parts by weight is preferable. When it is 0.1 parts by weight or greater, fluidity is more easily improved. In contrast, when it is 3.0 parts by weight or less, there are fewer free fluidizer fine particles, and filming on the photoconductor is more reliably prevented.

The ratio (A/B) between the titanium oxide fine particles (A) and the fluidizer fine particles (B) added is preferably in a range from 0.5 to 2.0, more preferably in a range from 0.75 to 1.5, and most preferably in a range from 0.8 to 1.3. In particular, 1.0 to 1.3 is preferable. When it is 0.5 or greater, spacer effects obtained by the titanium oxide fine particles are more easily obtained, and long-life properties are more excellent. When it is 2.0 or less, fluidity is further improved.

In the toner of the present invention, in order to adjust the fluidity, charging properties, cleaning properties, and storage ability, other inorganic fine particles, magnetic powder, carbon, talc, clay, calcium carbonate, magnesium carbonate, zine oxide, silicon carbide, aliphatic metals such as magnesium stearate and zinc stearate, various resin fine particles, and silicone oil may be attached to the main toner particles in addition to the first and second additives.

In order to attach the additives to the main toner particles, a method in which the main toner particles and the additives are agitated and mixed using a common mixer, such as a turbine type mixer, a Henschel mixer, and a super mixer can be used.

The main toner particles constituting the toner of the present invention contain a binder resin and a pigment, and if necessary, a charging controlling agent, a release agent, and a magnetic material. Any production methods can be used. For example, a melting-kneading-crushing method, a suspension polymerization method, an emulsion polymerization method, or a spray-dry method can be used. In particular, the main toner particles produced by the melting-kneading-crushing method are preferable.

Any binder resins which are commonly used in toners can be used. Examples of the binder resin include styrene resin, acrylic acid ester resin, styrene-acrylic acid ester copolymer resin, styrene-methacrylic acid ester copolymer resin, polyvinyl chloride, polyvinyl acetate, polyvinylidene chloride, phenol resin, epoxy resin, polyester resin, hydrogenated rosin, olefin resin, cycloolefin copolymer resin, cyclized rubber, polyacetate resin, and terpene phenol resin. These may be used alone or in combination.

Among these, styrene-acrylic acid ester copolymer resin and polyester resin are preferably used as the binder resin in the present invention.

It is preferable that a pigment or a dye be added, if necessary, to the main toner particles constituting the toner of the present invention. Any pigments commonly used in the toner can be used. Examples of the pigment include carbon black, aniline blue, calco oil blue, chrome yellow, ultramarine blue, Du Pont oil red, quinoline yellow, methylene blue chloride, phthalocyanine blue, malachite green oxalate, lampblack, and rose bengal.

It is necessary to add a sufficient amount of the pigment to form a visible image with sufficient density. For example, the amount of the pigment added to 100% by weight of the main toner particles is in a range from 0.5 to 20% by weight, and preferably in a range from 1 to 6% by weight. When the toner is a black toner, black magnetic material is also used as the pigment.

It is preferable that the main toner particles constituting the toner of the present invention contain wax in order to improve low temperature fixing ability and releasing ability when fixing. Examples of the wax used in the present invention include polyolefin wax such as polyethylene wax and polypropylene wax, synthetic wax such as Fischer-Tropsch wax, petroleum-based wax such as paraffin wax and microcrystalline wax, plant wax such as carnauba wax, candelilla wax, and rice wax, hardened oil such as cured castor oil, mineral wax such as montan wax, high fatty acids and esters thereof, and fatty acid amido. Among these, when releasing properties are desired to be improved, polyolefin wax such as polyethylene wax and polypropylene wax, and modified wax thereof are preferably used. Examples of the modified wax include oxide wax and graft-modified wax.

In the present invention, polypropylene wax and ester wax are preferably used.

It is preferable that the wax in a range from 0.5 to 15% by weight be added to 100% by weight of the main toner particles, more preferably in a range from 1 to 10% by weight, and most preferably in a range from 2 to 6% by weight. When the content of the wax is 0.5% by weight or greater, the wax provides sufficiently low temperature fixing ability and releasing properties to the toner. When it is 15% by weight or less, further excellent storage ability is obtained. Thereby, melting and attaching to the developing roller or the charged blade are prevented, separation of wax from the main toner particles is hardly generated, and black spot, filming, and the like to the photoconductor are also hardly generated.

It is preferable that the main toner particles constituting the toner of the present invention contain a charging controlling agent, if necessary. The charging controlling agent is added to provide polar character to the toner. The charging controlling agent is classified into a positive charged agent and a negative charged agent. However, both of the positive and negative charged agents can also be used at the same time.

Examples of the charging controlling agent used in the positive charged toner include nigrosine dye, quaternary ammonium salt, pyridinium salt, azine, triphenyl methane compound, and low molecular polymer having a cationic functional group. Examples of the charging controlling agent used in the negative charged toner include azo metal complex, salicylic acid metal complex, boron complex, and low molecular polymer having an anionic functional group.

The content of the charging controlling agent to the main toner particles is preferably in a range from 0.1 to 5% by weight, and more preferably in a range from 0.5 to 2.5% by weight.

The main toner particles may contain magnetic material, if necessary. Any magnetic fine materials, which have been used in the toner, can be used. Examples of the magnetic material used in the present invention include fine particles of metal such as cobalt, iron, and nickel; alloys such as aluminum alloy, copper alloy, nickel alloy, magnesium alloy, tin alloy, zinc alloy, gold alloy, silver alloy, selenium alloy, titanium alloy, tungsten alloy, zirconium alloy, and other alloys; metal oxides such as aluminum oxide, iron oxide, nickel oxide, ferrite, magnetite, and maghemite. In the present invention, ferrite and magnetite are preferably used, and magnetite is more preferably used. A sintered body mixture shown by the general formula of MeO—Fe₂O₃ is used as ferrite powder. In the general formula, MeO means an oxide of metal such as Mn, Zn, Ni, Ba, Co, Cu, Li, Mg, Cr, Ca, V, etc. These metal oxides can be used alone or in combination. Moreover, a sintered body mixture shown by FeO—Fe₂O₃ is used as magnetite powder.

The average particle diameter of the magnetic powder is preferably in a range from 0.05 to 3 μm, and more preferably in a range from 0.1 to 1 μm. When the average particle diameter of the magnetic powder is 0.05 μm or greater, the ratio of the magnetic powder exposed on the surface of the toner increases, and the charge flow becomes smooth. Thereby, the thickness of the toner layer on the developing sleeve is uniform. In addition, it is possible to prevent the consumption of the toner from increasing, and background fogging is also further prevented. When it is 3 μm or less, since the magnetic powder can be uniformly dispersed, decrease of the image density and generation of background fogging are further prevented. In addition, since the magnetic powder can be adequately exposed from the surface of the toner, long-life properties can be further improved without abrasion of the photoconductor and the surface of the developing sleeve.

The measuring method for the average particle diameter of the magnetic powder is described below.

Electron micrograms of the magnetic powder are taken by a scanning electron micrograph (marketed by JEOL Ltd.; trade name: JSM-5300). 100 magnetic particles are randomly selected in the electron microgram. Then, the long diameter D and the short diameter d of each magnetic particle are measured. Then, the value of (D+d)/2 is calculated. The average value of 100 magnetic particles is defined as the average particle diameter.

The magnetic particles have a spherical shape, needle shape, hexahedron shape, octahedron shape, polyhedron shape, and indeterminate shape. In the present invention, magnetic particles having any shape can be used.

When the toner of the present invention is a magnetic one-component toner, the content of the magnetic powder in the main toner particles is preferably in a range from 10 to 60% by weight, more preferably in a range from 25 to 60% by weight, and most preferably in a range from 35 to 50% by weight. When it is 10% by weight or greater, background fogging can be further prevented. In contrast, when it is 60% by weight or less, a desired image density can be obtained. Moreover, when the toner of the present invention is a magnetic two-component toner, the content of the magnetic powder is preferably in a range from 10 to 35% by weight.

The main toner particles in the present invention can be produced by mixing the binder resin, the pigment, and other additives, if necessary, at a mixing ratio, melting and kneading the obtained mixture, and then crushing and classifying (a melting-kneading-crushing method). In addition, other production methods such as a suspension polymerization method, an emulsion polymerization method, or a spray-dry method, can be used.

The volume average particle diameter (volume 50% diameter measured by a Coulter Multisizer II, marketed by Beckman Coulter Co., Ltd.) of the main toner particles constituting the toner of the present invention is preferably in a range from 5 to 12 μm, more preferably in a range from 6 to 10 μm, and most preferably in a range from 6 to 9 μm. When the volume average particle diameter of the main toner particles is 5 μm or greater, there is a low possibility that the fine particles having an average particle diameter of 3 μm or less are contained. Thereby, the possibility is also further decreased, in that the image density decreases, black spot and filming are generated on the photoconductor, and the toner is melted and attached on the developing sleeve and a blade for adjusting a toner layer thickness. In contrast, when it is 12 μm or less, the resolution is hardly decreased and images having high quality can be obtained.

In spite of a developing method, the toner of the present invention can be used in a two-component developing method using carriers, a non-magnetic one-component developing method, and a magnetic one-component developing method. Among these, the toner of the present invention is preferably used in the magnetic one-component developing method. In addition, the toner of the present invention can be used in any one of a contacting type method and a non-contacting type method in the magnetic one-component developing method.

When the toner of the present invention is a magnetic toner, the apparent density of the toner comprising the main toner particles and the additives is preferably in a range from 0.35 to 0.65 g/ml, and more preferably in a range from 0.40 to 0.60 g/ml.

When the the toner of the present invention is a non-magnetic toner, the apparent density of the toner comprising the main toner particles and the additives is preferably in a range from 0.30 to 0.55 g/ml, and more preferably in a range from 0.35 to 0.50 g/ml.

When the apparent density is the upper limit value or less, further excellent fluidity is obtained. In contrast, when it is the lower limit value or greater, long-life properties are further improved.

The apparent density is measured in accordance with JIS K 5101-12-1.

### Examples

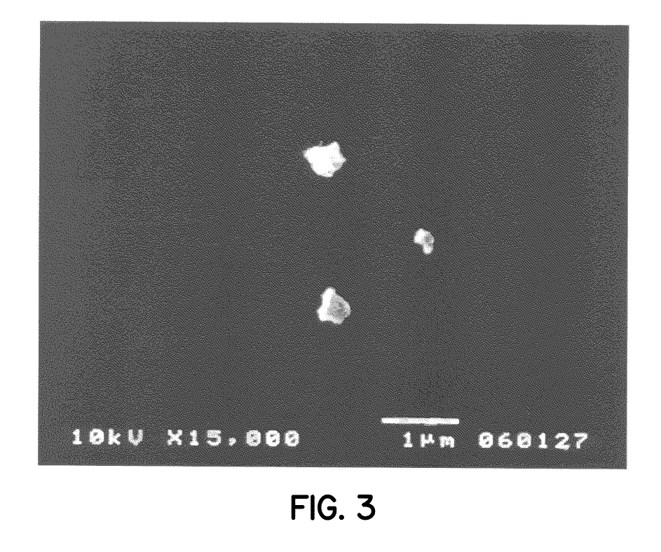

The present invention is explained in detail referring to Examples below. In Examples, “part” means “parts by weight”. The present invention is not limited to Examples.

[Titanium Oxide Fine Particles (First Additive)]
Titanium oxide fine particles A: spherical titanium oxide (anatase type; average primary particle diameter: 275 nm; circularity coefficient: 0.64)
Titanium oxide fine particles B: titanium oxide fine particles (average primary particle diameter: 275 nm; circularity coefficient: 0.66) obtained by treating the titanium oxide fine particles A with silicone oil. As shown in FIG. 1, spherical primary particles are coagulated. The primary particles do not contain ultra fine particles or ultra large particles, and particle diameter is uniform.
Titanium oxide fine particles C: titanium oxide fine particles (average primary particle diameter: 365 nm; circularity coefficient: 0.65) obtained by treating spherical titanium oxide fine particles (anatase type) with silicone oil.
Titanium oxide fine particles D: titanium oxide fine particles (average primary particle diameter: 90 nm) obtained by treating spherical titanium oxide fine particles (anatase type) with silicone oil. The primary particle diameter was too small to measure the circularity coefficient. As shown in FIG. 2, this is an aggregate comprising spherical primary particles.
Titanium oxide fine particles E: titanium oxide fine particles (average primary particle diameter: 170 nm; circularity coefficient: 0.60) obtained by treating spherical titanium oxide fine particles (anatase type) with silicone oil.
Titanium oxide fine particles F: titanium oxide fine particles (average primary particle diameter: 460 nm; circularity coefficient: 0.70) obtained by treating spherical titanium oxide fine particles (anatase type) with silicone oil.
Titanium oxide fine particles G: titanium oxide fine particles (average primary particle diameter: 300 nm; circularity coefficient: 0.50) obtained by treating non-spherical titanium oxide fine particles (anatase type) with silicone oil. As shown in FIG. 3, non-spherical primary particles are aggregated.

[Silicone Oil Treatment]

The titanium oxide was subjected to a surface treatment by adding marketed silicone oil to 100 parts of non-treated titanium oxide fine particles, and mixing.

[Fluidizer Fine Particles (Second Additive)]
Silica fine particles A: hydrophobic silica marketed by Clariant, trade name: HDK-H13TM, specific surface area: 130 m²/g
Silica fine particles B: hydrophobic silica marketed by Clariant, trade name: HDK-H30TM, specific surface area: 270 m²/g
Silica fine particles C: hydrophobic silica marketed by Clariant, trade name: HDK-H05TM, specific surface area: 50 m²/g
Silica fine particles D: hydrophobic silica marketed by Nippon Aerosil Co., Ltd, trade name: R-972, specific surface area: 140 m²/g
Silica fine particles E: hydrophobic silica marketed by Nippon Aerosil Co., Ltd, trade name: R-976, specific surface area: 280 m²/g
Silica fine particles F: hydrophobic silica marketed by Nippon Aerosil Co., Ltd, trade name: RX-50, specific surface area: 50 m²/g

[Production of the Main Toner Particles]

### Production of the Main Toner Particles A (Magnetic Main Toner Particles)

After the following materials were mixed by a super mixer, the mixture was melted and kneaded by a biaxial kneading device, and then this was rolled and cooled. Then, this was roughly crushed by a hammer mill, and then further crushed by an impact crusher (marketed by Kawasaki Heavy Industries, Ltd.; trade name: Krypton KTM-EX). After that, the main toner particles A having a volume average particle diameter of 8.5 μm were obtained by classifying by a dry air current classifier.

| | |
|---|---|
| Styrene-acrylic acid ester copolymer resin | 53 parts |
| (marketed by Sanyo Chemical Industries Ltd.; trade name: | |
| ST-305) | |
| Polypropylene wax | 5 parts |
| (marketed by Sanyo Chemical Industries Ltd.; trade name: | |
| Viscol 550P) | |
| Charging controlling agent | 2 parts |
| (negative polarity containing a metal complex, marketed by | |
| Orient Chemical Industries, Ltd.; trade name: S-34) | |
| Magnetite | 40 parts |
| (octahedron shape, marketed by Toda Kogyo Corp.; | |
| trade name: EPT-1002; average particle diameter 0.23 μm) | |

Production of the Main Toner Particles B (Non-Magnetic Main Toner Particles)

The main toner particles B having a volume average particle diameter of 8.5 μm were obtained using the following materials in a manner identical to that of the main toner particles A.

| | |
|---|---|
| Polyester resin | 89 parts |
| (marketed by Mitsubishi Rayon Co., Ltd.: trade name: | |
| FC-433) | |
| Polypropylene wax | 2 parts |
| (marketed by Sanyo Chemical Industries Ltd.; trade name: | |
| Viscol 550P) | |
| Ester wax | 2 parts |
| (marketed by Nippon Yuka Kogyo Co., Ltd.; trade name: | |
| WEP-8) | |
| Charging controlling agent | 1 part |
| (negative polarity containing a metal complex, marketed by | |
| Orient Chemical | |
| Industries, Ltd.; trade name: S-34) | |
| Carbon black | 6 parts |
| (marketed by Cabot Corporation; trade name: | |
| REGAL ® 330R) | |

Production of the Main Toner Particles C (Non-Magnetic Main Toner Particles Containing a Cyan Pigment)

The main toner particles C having a volume average particle diameter of 6.3 μm were obtained using the following materials in a manner identical to that of the main toner particles A.

| | |
|---|---|
| Polyester resin | 89 parts |
| (marketed by Mitsubishi Rayon Co., Ltd.: trade name: | |
| FC-433) | |
| Polypropylene wax | 2 parts |
| (marketed by Sanyo Chemical Industries Ltd.; trade name: | |
| Viscol 550P) | |
| Ester wax | 2 parts |
| (marketed by Nippon Yuka Kogyo Co., Ltd.; trade name: | |
| WEP-8) | |
| Charging controlling agent | 1 part |
| (negative polarity containing a boron complex, marketed by | |
| Japan Carlit Co., Ltd.; trade name: LR-147) | |
| Cyan pigment | 6 parts |
| (marketed by Dainichiseika Color & Chemicals Mfg. Co., | |
| Ltd.; trade name: ECB-303) | |

Production of the Toner

### Examples 1 to 3 and Comparative Examples 1 to 6

To 100 parts of the main toner particles A in a Henschel mixer (marketed by Mitsui Mining Co., Ltd.), additives were added so as to have the composition as shown in Table 1, and stirred for three minutes, and thereby the toner of Examples 1 to 3 and Comparative Examples 1 to 6 was produced.

Then, the produced toner was evaluated using a printer in a non-contact type magnetic one-component developing system (having a function for recovering toner remaining on the photoconductor after transferring). Specifically, paper in A4-size having a black printing ratio of 5% was printed at a printing rate such that 30 sheets of A4 paper were printed in a longitudinal direction in one minute under the conditions of 23° C., 55% RH.

As initial characters, the following reproducibility of printing in all black and background fogging were evaluated.

As characters after a continuous printing test, the following reproducibility of printing in all black, background fogging, damage of the photoconductor, and transfer efficiency after printing 30,000 sheets of paper were evaluated.

The obtained results are shown in Table 1.

### Examples 4 to 6 and Comparative Examples 7 to 12

The toner in Examples 4 to 6 and Comparative Examples 7 to 12 was obtained in a manner identical to that of Example 1, except that the additives were added to the 100 parts of the main toner particles B so as to have the composition as shown in Table 2.

Then, the produced toner was evaluated using a printer in a contact type non-magnetic one-component developing system (having no function for recovering toner remaining on the photoconductor after transferring). Specifically, paper in A4-size having a black printing ratio of 5% was printed at a printing rate such that 18 sheets of A4 paper were printed in a longitudinal direction in one minute under the conditions of 23° C., 55% RH.

As initial characters, the following reproducibility of printing in all black and background fogging were evaluated.

As characters after a continuous printing test, the following reproducibility of printing in all black, background fogging, damage of the photoconductor, melting and attaching of the toner to a charged blade, and existence of ghost after printing 10,000 sheets of paper were evaluated.

### Examples 7 to 9 and Comparative Examples 13 to 18

The toner in Examples 7 to 9 and Comparative Examples 13 to 18 was obtained in a manner identical to that of Example 1, except that the additives were added to 100 parts of the main toner particles C so as to have the composition as shown in Table 3.

Then, the produced toner was evaluated using a printer in a contact type non-magnetic one-component developing system (having no function for recovering toner remaining on the photoconductor after transferring). Specifically, paper in A4-size having a black printing ratio of 5% was printed at a printing rate such that 12 sheets of A4 paper were printed in a longitudinal direction in one minute under the conditions of 23° C., 55% RH.

As initial characters, the following reproducibility of printing in all black, background fogging, and fine line repeatability were evaluated.

As characters after a continuous printing test, the following reproducibility of printing in all black, background fogging, damage of the photoconductor, and fine line repeatability after printing 5,000 sheets of paper were evaluated.

The evaluation method for each evaluation item is below.

(1) Reproducibility of printing in all black: After printing continuously 5 sheets of paper in A4 size in all black in the longitudinal direction (all portions other than the 5 mm wide margin were printed in black), thin or insufficiently blacked image areas were observed. When fluidity or frictional charging properties are degraded, since an amount of the toner needed to develop all black images is not supplied to the developing roller and the photoconductor, the black image is insufficient or thin. That is, all black printing is not accurately performed. Evaluation standard is below.

### Evaluation Standard in Examples 1 to 3 and Comparative Examples 1 to 6

Good: No insufficient or thin areas were observed on the 5th sheet of printed paper.

Fair: Insufficient or thin areas were observed on the 3rd to 5th sheets of printed paper.

Poor: Insufficient or thin areas were observed on the 1st or 2nd sheet of printed paper.

### Evaluation Standard in Examples 4 to 9 and Comparative Examples 7 to 18

Good: No insufficient or thin areas were observed on the 3rd sheet of printed paper.

Fair: Insufficient or thin areas were observed on the 2nd or 3^{rd} sheet of printed paper.

Poor: Insufficient or thin areas were observed on the 1st sheet of printed paper.

(2) Background fogging: The whiteness at a non-image portion was measured using ZE2000 Color Meter made by Nippon Denshoku Industries, Ltd., and the difference in whiteness before and after printing is defined as background fogging. When the frictional charging amount is insufficient, background fogging is caused in non-image portions.

Evaluation standard is below.

Good: Less than 1.0

Fair: 1.0 or greater and less than 1.5

Poor: 1.5 or greater

(3) Damage of the photoconductor: The surface of the photoconductor was observed. Evaluation standard is below.

Good: No filming or scratches

Fair: Small amount of filming or small scratches

Poor: Large amount of filming or large scratches

(4) Transfer efficiency: The transfer efficiency was calculated by the following formula based on the difference between an amount of the toner consumed and an amount of the toner recovered in the continuous printing test. The transfer efficiency is preferably 80% in practical use.

Transfer efficiency (%)=(An amount of the toner consumed−An amount of the toner recovered)×100/An amount of the toner consumed

(5) Melting and attaching to a charged blade: The conditions of melting and attaching of the toner to a charged blade were observed. Evaluation standard is below.
Good: No melting and attaching were observed.
Fair: Melting and attaching were observed, but there was no influence on the images.
Poor: Much melting and attaching were observed, and lines were observed in the images.

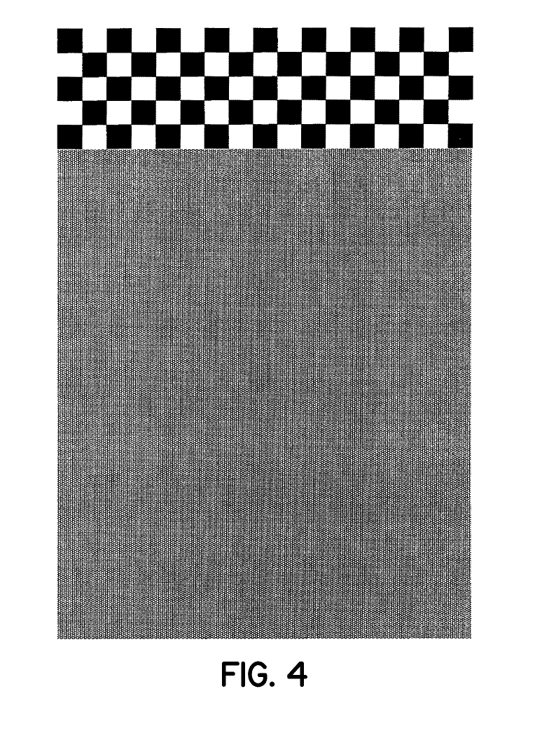

(6) Ghost: The pattern shown in FIG. 4 was printed, the printed image was observed. Ghost is a phenomenon that is caused by transferring the toner remaining on the surface of the photoconductor on successive images when the photoconductor does not comprise a cleaning device. Evaluation standard is below.

Good: No ghosts were observed.

Fair: Ghosts were observed.

Poor: Ghosts were highly observed.

(7) Fine line repeatability: Line images of 200 lines/inch were observed using a magnifier of 50 times. Then the number of insufficient portions or thin portions in a line 15 mm in length was counted. Fine line repeatability is important for full-color printing with high quality.

Good: Number of insufficient portions or thin portions is 5 or less.

Fair: Number of insufficient portions or thin portions is 6 to 10.

Poor: Number of insufficient portions or thin portions is 11 or greater.

TABLE 1

| | | | | | Com. | Com. |
|---|---|---|---|---|---|---|
| | | Example 1 | Example 2 | Example 3 | Example 1 | Example 2 |
| Additives | Titanium oxide | B: 0.8% | C: 0.8% | A: 0.8% | D: 0.7% | E: 0.8% |
| | fine particles | | | | | |
| | Silica | A: 0.7% | A: 0.7% | A: 0.7% | A: 0.7% | A: 0.7% |
| Bulk specific gravity | | 0.51 | 0.49 | 0.51 | 0.55 | 0.55 |
| Initial characters | Reproducibility of | Good | Good | Fair | Good | Good |
| | printing in all black | No | No | Insufficient | No | No |
| | | Insufficient | Insufficient | area were | Insufficient | Insufficient |
| | | areas were | areas were | observed | areas were | areas were |
| | | observed | observed | on the 4th | observed | observed |
| | | on the 5th | on the 5th | sheet | on the 5th | on the 5th |
| | | sheet | sheet | | sheet | sheet |
| | Background fogging | Good | Good | Good | Good | Good |
| Characters after | Reproducibility of | Good | Good | Fair | Poor | Poor |
| 30,000 printings | printing in all black | No | No | Insufficient | Insufficient | Insufficient |
| | | Insufficient | Insufficient | areas were | areas were | areas were |
| | | areas were | areas were | observed | observed | observed |
| | | observed | observed | on the 3rd | on the 1st | on the |
| | | on the 5th | on the 5th | sheet | sheet | 2nd sheet |
| | | sheet | sheet | | | |
| | Background fogging | Good | Good | Fair | Fair | Good |
| | Damage of | Good | Good | Good | Poor | Fair |
| | photoconductor | No | No | No | Much | Small |
| | | damage | damage | damage | filming | filming |
| | Transfer efficiency | 92% | 91% | 80% | 85% | 90% |

| | | Com. | Com. | Com. | Com. |
|---|---|---|---|---|---|
| | | Example 3 | Example 4 | Example 5 | Example 6 |
| Additives | Titanium oxide | F: 0.9% | G: 0.8% | B: 0.8% | B: 0.8% |
| | fine particles | | | | |
| | Silica | A: 0.7% | A: 0.7% | B: 0.5% | C: 0.9% |
| Bulk specific gravity | | 0.40 | 0.48 | 0.59 | 0.38 |
| Initial characters | Reproducibility of | Poor | Good | Good | Poor |
| | printing in all black | Insufficient | No | No | Insufficient |
| | | area were | Insufficient | Insufficient | areas were |
| | | observed | areas were | areas were | observed |
| | | on the 1st | observed | observed | on the |
| | | sheet | on the 5th | on the 5th | 2nd sheet |
| | | | sheet | sheet | |
| | Background fogging | Fair | Good | Good | Good |
| Characters after 30,000 printings | Reproducibility of | Poor | Fair | Good | Poor |
| | printing in all black | Insufficient | Insufficient | No | Insufficient |
| | | areas were | areas were | Insufficient | areas were |
| | | observed | observed | areas were | observed |
| | | on the 1st | on the | observed | on the 1st |
| | | sheet | 4th sheet | on the 5th | sheet |
| | | | | sheet | |
| | Background fogging | Poor | Good | Fair | Poor |
| | Damage of | Good | Poor | Poor | Good |
| | photoconductor | No | Many | Much | No |
| | | damage | scratches | filming | damage |
| | Transfer efficiency | 75% | 88% | 88% | 81% |

As shown in Table 1, the toner in Examples 1 to 3 had no problems in practical use.

In contrast, since the average primary particle diameter of the titanium oxide fine particles used in the toner in Comparative Example 1 was small, 90 nm, the toner had inferior spacer effects. Therefore, after the continuous printing test, the reproducibility of printing in all black was low, the damage of photoconductor was observed, and the background fogging was also large.

The average primary particle diameter of the titanium oxide fine particles used in the toner in Comparative Example 2 was slightly small, 170 nm. Therefore, the reproducibility of printing in all black was low and the damage of the photoconductor was observed after the continuous printing test. The toner in Comparative Example 2 had problems in practical use.

The average primary particle diameter of the titanium oxide fine particles used in the toner in Comparative Example 3 was slightly large, 460 nm. Therefore, the initial reproducibility of printing in all black was low. After the continuous printing test, the background fogging was large, and the transfer efficiency was small.

In the toner in Comparative Example 4, since the titanium oxide fine particles were not spherical, many scratches were observed on the surface of the photoconductor after the continuous printing test.

In the toner in Comparative Example 5, since the specific surface area of the silica was large, 270 m²/g, much filming was observed on the surface of the photoconductor after the continuous printing test.

In the toner in Comparative Example 6, since the specific surface area of the silica was small, 50 m²/g, the initial reproducibility of printing in all black was low. In addition, the background fogging after the continuous printing test was large.

TABLE 2

| | | | | | Com. | Com. |
|---|---|---|---|---|---|---|
| | | Example 4 | Example 5 | Example 6 | Example 7 | Example 8 |
| Additives | Titanium oxide | B: 0.8% | C: 0.8% | A: 0.8% | D: 0.7% | E: 0.8% |
| | fine particles | | | | | |
| | Silica | D: 0.8% | D: 0.8% | D: 0.8% | D: 0.8% | D: 0.8% |
| Bulk specific gravity | | 0.40 | 0.40 | 0.42 | 0.42 | 0.41 |
| Initial characters | Reproducibility of | Good | Good | Good | Good | Good |
| | printing in all black | No | No | No | No | No |
| | | Insufficient | Insufficient | Insufficient | Insufficient | Insufficient |
| | | areas were | areas were | areas were | areas were | areas were |
| | | observed | observed | observed | observed | observed |
| | | on the 3rd | on the 3rd | on the 3rd | on the 3rd | on the 3rd |
| | | sheet | sheet | sheet | sheet | sheet |
| | Background fogging | Good | Good | Good | Good | Good |
| Characters after | Reproducibility of | Good | Good | Good | Poor | Fair |
| 10,000 printings | printing in all black | No | No | No | Insufficient | Insufficient |
| | | Insufficient | Insufficient | Insufficient | areas were | areas were |
| | | areas were | areas were | areas were | observed | observed |
| | | observed | observed | observed | on the 1st | on the 2nd |
| | | on the 3rd | on the 3rd | on the 3rd | sheet | sheet |
| | | sheet | sheet | sheet | | |
| | Background fogging | Good | Good | Fair | Fair | Good |
| | Damage of | Good | Good | Good | Poor | Fair |
| | photoconductor | No | No | No | Much | Small |
| | | damage | damage | damage | filming | filming |
| | Melting and | Good | Good | Good | Poor | Fair |
| | attaching to a | | | | | |
| | charged plate | | | | | |
| | Ghost | Good | Good | Fair | Poor | Fair |

| | | | Com. | Com. | Com. |
|---|---|---|---|---|---|
| | | Com. | Example | Example | Example |
| | | Example 9 | 10 | 11 | 12 |
| Additives | Titanium oxide | F: 0.9% | G: 0.8% | B: 0.8% | B: 0.8% |
| | fine particles | | | | |
| | Silica | D: 0.8% | D: 0.8% | E: 0.6% | F: 1.0% |
| Bulk specific gravity | | 0.32 | 0.39 | 0.46 | 0.31 |
| Initial characters | Reproducibility of | Poor | Good | Good | Poor |
| | printing in all black | Insufficient | No | No | Insufficient |
| | | areas were | Insufficient | Insufficient | areas were |
| | | observed | areas were | areas were | observed |
| | | on the 1st | observed | observed | on the 1st |
| | | sheet | on the 3rd | on the 3rd | sheet |
| | | | sheet | sheet | |
| | Background fogging | Fair | Good | Good | Fair |
| Characters after 10,000 printings | Reproducibility of | Poor | Fair | Poor | Poor |
| | printing in all black | Insufficient | Insufficient | Insufficient | Insufficient |
| | | areas were | areas were | areas were | areas were |
| | | observed | observed | observed | observed |
| | | on the 1st | on the 2nd | on the 1st | on the 1st |
| | | sheet | sheet | sheet | sheet |
| | Background fogging | Poor | Good | Fair | Poor |
| | Damage of | Good | Poor | Poor | Good |
| | photoconductor | No | Many | Much | No |
| | | damage | scratches | filming | damage |
| | Melting and | Fair | Good | Poor | Good |
| | attaching to a | | | | |
| | charged plate | | | | |
| | Ghost | Poor | Fair | Fair | Poor |

As shown in Table 2, the toner in Examples 4 to 6 had no problems in practical use.

In contrast, since the average primary particle diameter of the titanium oxide fine particles used in the toner in Comparative Example 7 was small, 90 nm, the toner had inferior spacer effects. Therefore, after the continuous printing test, the reproducibility of printing in all black was low, the damage of the photoconductor was observed, the melting and attaching to a charged blade were observed, the ghost was observed, and background forgging was slightly large.

The average primary particle diameter of the titanium oxide fine particles used in the toner in Comparative Example 8 was slightly small, 170 nm. Therefore, the reproducibility of printing in all black was low, the damage of photoconductor and ghost were observed, and the melting and attaching of the toner to a charged blade was also observed after the continuous printing test. The toner in Comparative Example 8 had problems in practical use.

The average primary particle diameter of the titanium oxide fine particles used in the toner in Comparative Example 9 was slightly large, 460 mu. Therefore, the initial reproducibility of printing in all black was low. After the continuous printing test, the background fogging was large and the ghost was observed. In addition, the melting and attaching of the toner to a charged blade was also observed.

In the toner in Comparative Example 10, since the titanium oxide fine particles were not spherical, many scratches were observed on the surface of the photoconductor after the continuous printing test.

In the toner in Comparative Example 11, since the specific surface area of the silica was large, 280 m²/g, the reproducibility of printing in all black was low, much filming was observed on the surface of the photoconductor, and the melting and attaching of the toner to the charged blade was also observed after the continuous printing test.

In the toner in Comparative Example 12, since the specific surface area of the silica was small, 50 m²/g, the initial reproducibility of printing in all black was low. In addition, the background fogging was large, and the ghost was also observed after the continuous printing test.

TABLE 3

| | | | | | Com. | Com. |
|---|---|---|---|---|---|---|
| | | | | | Example | Example |
| | | Example 7 | Example 8 | Example 9 | 13 | 14 |
| Additives | Titanium oxide | B: 1.5% | C: 1.5% | A: 1.5% | D: 1.5% | E: 1.5% |
| | fine particles | | | | | |
| | Silica | A: 1.3% | A: 1.3% | A: 1.3% | A: 1.3% | A: 1.3% |
| Bulk specific gravity | | 0.45 | 0.44 | 0.46 | 0.44 | 0.44 |
| Initial characters | Reproducibility of | Good | Good | Good | Good | Good |
| | printing in all black | No | No | No | No | No |
| | | Insufficient | Insufficient | Insufficient | Insufficient | Insufficient |
| | | areas were | areas were | areas were | areas were | areas were |
| | | observed | observed | observed | observed | observed |
| | | on the 3rd | on the 3rd | on the 3rd | on the 3rd | on the 3rd |
| | | sheet | sheet | sheet | sheet | sheet |
| | Background fogging | Good | Good | Good | Good | Good |
| | Fine line repeatability | Good | Good | Good | Good | Good |
| Characters after | Reproducibility of | Good | Good | Good | Poor | Fair |
| 5,000 printings | printing in all black | No | No | No | Insufficient | Insufficient |
| | | Insufficient | Insufficient | Insufficient | areas were | areas were |
| | | areas were | areas were | areas were | observed | observed |
| | | observed | observed | observed | on the 1st | on the 2nd |
| | | on the 3rd | on the 3rd | on the 3rd | sheet | sheet |
| | | sheet | sheet | sheet | | |
| | Background fogging | Good | Good | Good | Fair | Good |
| | Damage of | Good | Good | Good | Poor | Fair |
| | photoconductor | No | No | No | Much | Small |
| | | damage | damage | damage | filming | filming |
| | Fine line repeatability | Good | Good | Fair | Fair | Fair |

| | | Com. | Com. | Com. | Com. |
|---|---|---|---|---|---|
| | | Example | Example | Example | Example |
| | | 15 | 16 | 17 | 18 |
| Additives | Titanium oxide | F: 1.8% | G: 1.5% | B: 1.5% | B: 1.5% |
| | fine particles | | | | |
| | Silica | A: 1.3% | A: 1.3% | B: 1.0% | C: 2.0% |
| Bulk specific gravity | | 0.40 | 0.45 | 0.48 | 0.38 |
| Initial characters | Reproducibility of | Poor | Good | Good | Poor |
| | printing in all black | Insufficient | No | No | Insufficient |
| | | areas were | Insufficient | Insufficient | areas were |
| | | observed | areas were | areas were | observed |
| | | on the 1st | observed | observed | on the 1st |
| | | sheet | on the 3rd | on the 3rd | sheet |
| | | | sheet | sheet | |
| | Background fogging | Fair | Good | Good | Fair |
| | Fine line repeatability | Poor | Fair | Good | Fair |
| Characters after 5,000 printings | Reproducibility of | Poor | Fair | Poor | Poor |
| | printing in all black | Insufficient | Insufficient | Insufficient | Insufficient |
| | | areas were | areas were | areas were | areas were |
| | | observed | observed | observed | observed |
| | | on the 1st | on the 2nd | on the 1st | on the 1st |
| | | sheet | sheet | sheet | sheet |
| | Background fogging | Poor | Good | Fair | Poor |
| | Damage of | Good | Poor | Poor | Good |
| | photoconductor | No | Many | Much | No |
| | | damage | scratches | filming | damage |
| | Fine line repeatability | Poor | Fair | Poor | Poor |

As shown in Table 3, the toner in Examples 7 to 9 had no problems in practical use.

In contrast, since the average primary particle diameter of the titanium oxide fine particles used in the toner in Comparative Example 13 was small, 90 nm, the toner had inferior spacer effects. Therefore, after the continuous printing test, the reproducibility of printing in all black was low, the damage of the photoconductor was observed, the background fogging was large, and the fine line repeatability was also slightly degraded.

The average primary particle diameter of the titanium oxide fine particles used in the toner in Comparative Example 14 was slightly small, 170 rim. Therefore, the damage of photoconductor was observed, the reproducibility of printing in all black was low, and the fine line repeatability was degraded. The toner in Comparative Example 14 had problems in practical use.

The average primary particle diameter of the titanium oxide fine particles used in the toner in Comparative Example 15 was slightly large, 460 nm. Therefore, the initial reproducibility of printing in all black was low, and the initial fine line repeatability was degraded. In addition, after the continuous printing test, the background fogging was large.

In the toner in Comparative Example 16, since the titanium oxide fine particles were not spherical, many scratches were observed on the surface of the photoconductor after the continuous printing test. In addition the reproducibility of printing in all black was low, and the fine line repeatability was also degraded.

In the toner in Comparative Example 17, since the specific surface area of the silica was large, 270 m²/g, the reproducibility of printing in all black was low, the fine line repeatability was degraded, and much filming was observed on the surface of the photoconductor after the continuous test.

In the toner in Comparative Example 18, since the specific surface area of the silica was small, 50 m²/g, the initial reproducibility of printing in all black was low. In addition, the background fogging was large, and the fine line repeatability was also degraded after the continuous printing test.

### INDUSTRIAL APPLICABILITY

A developing method is no object in the toner of the present invention. For example, the toner of the present invention can be used in the two-component developing method, the non-magnetic one-component developing method, and the magnetic one-component developing method. In particular, the toner of the present invention is a toner used the in one-component developing method, which has stable fluidity and charging properties for a long time, excellent transfer facility, can form a uniform toner layer on the developing roller, does not cause image defects and cause scratches on the photoconductor, and has excellent transferring properties and transfer efficiency.

1. An electrophotographic toner comprising main toner particles and at least titanium oxide fine particles and fluidizer fine particles which are attached on the surface of the main toner particles,
wherein the titanium oxide fine particles are spherical and have an average primary diameter in a range from 200 to 400 nm, and the fluidizer fine particles have a specific surface area in a range from 60 to 250 m²/g.

2. An electrophotographic toner according to claim 1, wherein a circularity coefficient of the titanium oxide fine particles is 0.55 or greater.

3. An electrophotographic toner according to claim 1, wherein a surface of the titanium oxide fine particles is treated with silicone oil.

4. An electrophotographic toner according to claim 1, wherein the titanium oxide fine particles are produced by a sulfuric acid method.

5. An electrophotographic toner according to claim 1, wherein the titanium oxide fine particles are produced by a method comprising:
(1) a dissolving step in which dried and crushed ilmenite ore is dissolved in sulfuric acid, and a solution containing mainly titanium oxysulfate (TiOSO₄) and iron sulfate (Fe SO₄) is obtained;
(2) a cooling and separation step in which a concentrated solution is obtained by separating ferrous sulfate (FeSO₄.7H₂O), which is crystallized by cooling the solution, with a centrifugal device;
(3) a hydrolysis step in which the concentrated solution from which ferrous sulfate is removed is heated to separate titanium oxyhydroxide (TiO(OH)₂) and sulfuric acid
(4) a burning step in which a white precipitate of titanium hydroxide obtained by hydrolysis is fully washed with water and filtrate, and then burned to obtain titanium oxide (TiO₂); and
(5) a finishing step in which the burned titanium oxide is subjected to a surface treatment, filtrated, dried, and then crushed to obtain a final product.

6. An electrophotographic toner according to claim 1, wherein a content of titanium oxide in the titanium oxide fine particles is 90% or greater.

7. An electrophotographic toner according to claim 1, wherein a ratio (A/B) between the titanium oxide fine particles (A) and the fluidizer fine particles (B) added is in a range from 0.5 to 2.0.

8. An electrophotographic toner according to claim 1, wherein the toner is used in a magnetic one-component developing method.
